(19) United States
(12) Patent Application Publication
(10) Pub. No.: US 2026/0064495 A1
(43) Pub. Date: Mar. 5, 2026

(54) SYSTEMS AND METHODS FOR GENERATING APPLICATION PROGRAMMING INTERFACE (API) SCHEMA

(71) Applicant: ACCENTURE GLOBAL SOLUTIONS LIMITED, Dublin 4 (IE)

(72) Inventors: Roei LEVI, Mevaseret Zion (IL); Moshe Hadad, Rosh Haayin (IL); Lior Bass, Ramat Gan (IL)

(73) Assignee: ACCENTURE GLOBAL SOLUTIONS LIMITED, Dublin 4 (IE)

(21) Appl. No.: 18/818,245

(22) Filed: Aug. 28, 2024

(51) Int. Cl. G06F 9/54; G06N 5/022

(52) U.S. Cl. CPC G06F 9/54; G06N 5/022

(57) ABSTRACT

The present disclosure discloses systems and methods for generating application programming interface (API) schema by using ontological constructs. The system may receive an ontology file comprising a domain-specific conceptual model, wherein the domain-specific conceptual model comprises ontological entities and corresponding relationship between ontological entities. Further, a schema generation strategy may be determined from at least one of a simple strategy, a nearest neighbor strategy, and a shortest path strategy for the received ontology file based on a user requirement and the received ontology file. Moreover, the system may generate an ontological data structure for the received ontology file based on the determined schema generation strategy. Thereafter, the system may transform the generated ontological data structure into a graphical schema structure by mapping each of the ontological entities to corresponding graphical entities. Furthermore, the transformed graphical schema structure may be serialized output the generated graphical schema file as an API.

### FIELD OF THE INVENTION

Various embodiments described herein relate generally to an application programming interface (API) schema. Specifically, a system and a method for generating a graphical schema as an application programming interface (API) by using ontological constructs, is disclosed.

### BACKGROUND

In the last decade, the rise of big data and Artificial Intelligence (AI) revived the usage of and interest in knowledge graphs. Specifically, the utilization of graph databases as data repositories for domain-specific conceptual models, often represented as ontologies. These knowledge graphs capture the intricate relationships among various entities and provide a structured framework for understanding complex domains.

Utilizing those features, complex systems are built around those databases to deliver the value of descriptive, predictive, and prescriptive graph analyses. Facilitated by application programming interfaces (APIs), these models can be seamlessly communicated across those systems and different platforms, enabling efficient data exchange and interoperability.

However, a notable challenge arises with the dynamic nature of ontologies. There is difficulty in altering or modifying APIs when the underlying conceptual model (ontology) undergoes changes. This necessitates careful consideration and strategic planning to ensure the smooth evolution of APIs alongside evolving ontologies, thereby maintaining the integrity and functionality of the systems.

### SUMMARY

Implementations of the present disclosure are generally directed to application programming interface (API) schema generation using machine learning (ML) and deep learning (DL) techniques. More particularly, implementations of the present disclosure are directed to systems and methods for generating application programming interface (API) schema using ontological constructs.

In general, innovative aspects of the subject matter described in this specification provide systems and methods for generating application programming interface (API) schema by using ontological constructs. The system may receive an ontology file comprising a domain-specific conceptual model, wherein the domain-specific conceptual model comprises ontological entities and corresponding relationship between ontological entities. The system may further, determine a schema generation strategy from at least one of a simple strategy, a nearest neighbor strategy, and a shortest path strategy for the received ontology file based on a user requirement and the received ontology file. Moreover, the system may generate an ontological data structure for the received ontology file based on the determined schema generation strategy. Herein, the ontological data structure comprises the ontological entities mapped to a plurality of ontological classes in a predefined manner based on the relationship between the ontological entities and based on properties associated with the ontological entities. Thereafter, the system may transform the generated ontological data structure into a graphical schema structure by mapping each of the ontological entities to corresponding graphical entities based on the selected schema generation strategy and the generated ontological data structure. Furthermore, the system may generate a graphical schema file for the transformed graphical schema structure by serializing the transformed graphical schema structure and output the generated graphical schema file as an application programming interface (API).

The present disclosure further describes a system for implementing the methods provided herein. The present disclosure also describes non-transitory computer readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DRAWINGS

Various embodiments in accordance with the present disclosure will be described with reference to the drawings, in which:

FIG. 1 illustrates an example environment that may be used to execute implementations of the present disclosure.

FIG. 2 illustrates an example of a system architecture for generating an application programming interface (API), in accordance with implementations of the present disclosure.

FIG. 3 illustrates an exemplary implementation the graphical schema structure based on the schema generation strategy to be the nearest neighbor strategy, in accordance with implementations of the present disclosure.

FIG. 4 illustrates an exemplary implementation the graphical schema structure based on the schema generation strategy to be the shortest path strategy, in accordance with implementations of the present disclosure.

FIG. 5 illustrates the flow diagram of an example method for generating application programming interface (API) schema, in accordance with implementations of the present disclosure.

FIG. 6 illustrates the flow diagram of an example method for transforming the generated ontological data structure into the graphical schema structure based on the schema generation strategy to be the simple strategy, in accordance with implementations of the present disclosure.

FIG. 7 illustrates the flow diagram of an example method 700 for transforming the generated ontological data structure into the graphical schema structure based on the schema generation strategy to be the nearest neighbor strategy, in accordance with implementations of the present disclosure.

FIG. 8 illustrates the flow diagram of an example method 800 for transforming the generated ontological data structure into the graphical schema structure based on the schema generation strategy to be the shortest path strategy, in accordance with implementations of the present disclosure.

FIG. 9 illustrates a computer system that may be used for generating application programming interface (API) schema, in accordance with implementations of the present disclosure, in accordance with implementations of the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” (e.g., “for example”, “an example of”, by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

Software systems that are built around data typically require maintaining a database schema, a software data model, and an interface (API) for performing operations on the data. Maintaining APIs and software data models poses several challenges that need to be addressed to ensure the long-term success and sustainability of a software system. One key challenge is the evolution of APIs and data models over time. As requirements change, new features are added, or new data is updated, the APIs and data models must be updated accordingly. Maintaining a coherent API, that fits the software and that matches the underlying data, is required. In essence, an automatic process for creating and updating an API for software systems is required to be developed.

In view of this, implementations of the present disclosure propose systems and methods for generating application programming interface (API) schema using ontological constructs, to overcome above mentioned drawbacks of traditional systems and methods. The present disclosure utilizes ontological constructs that may include formal representation of knowledge within a specific domain, consisting of a set of concepts, properties, and the relationships between them. Specifically, the present disclosure discloses a novel approach for automatically generating protocol-based application programming interface (API) from ontological constructs using schema generation strategy including, but not limited to, a simple strategy, a nearest neighbor strategy, and a shortest path strategy. Moreover, the ontological constructs may define the software models and the relationships between them, thereby enabling the software system to easily adapt in response to the evolution of an ontology, ensuring that the API remains current and functional.

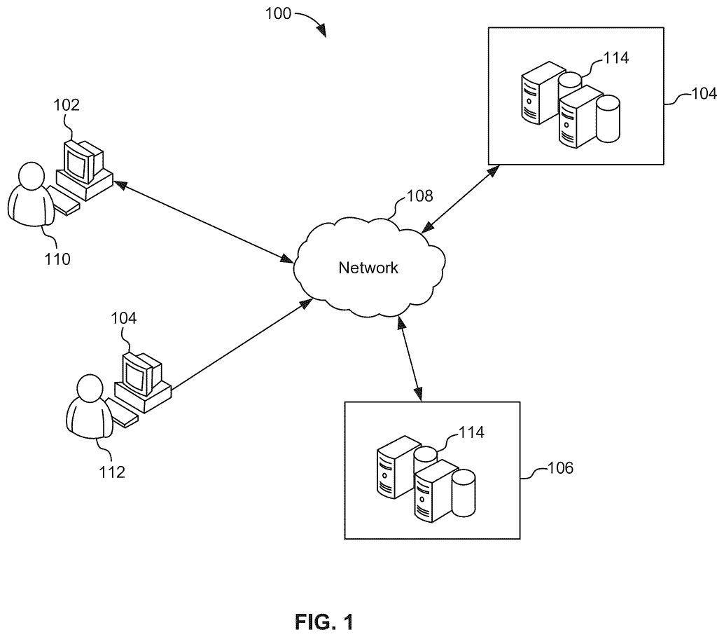

FIG. 1 depicts an example environment 100 that can be used to execute implementations of the present disclosure. In some examples, the example environment 100 enables users associated with respective systems to execute requests to generate content by invoking a trained language model in accordance with implementations of the present disclosure. The example environment 100 includes computing devices 102 and 104, back-end systems 106, and a network 108. In some examples, the computing devices 102 and 104 are used by respective users 110 and 112 to log into and interact with the platforms and running applications according to implementations of the present disclosure.

In the depicted example, the computing devices 102 and 104 are depicted as desktop computing devices. It is contemplated, however, that implementations of the present disclosure can be realized with any appropriate type of computing device (e.g., smartphone, tablet, laptop computer, voice-enabled devices). In some examples, the network 110 includes a local area network (LAN), wide area network (WAN), the Internet, or a combination thereof, and connects web sites, user devices (e.g., computing devices 102, 104), and back-end systems (e.g., the back-end systems 106). In some examples, the network 108 can be accessed over a wired and/or a wireless communications link. For example, mobile computing devices, such as smartphones can utilize a cellular network to access the network 108.

In the depicted example, the back-end systems 106 each include at least one server system 114. In some examples, the at least one server system 114 hosts one or more computer implemented services that users can interact with by using computing devices. For example, components of enterprise systems and applications can be hosted on one or more of the back-end systems 106. In some examples, a back-end system can be provided as an on-premises system that is operated by an enterprise or a third-party taking part in cross-platform interactions and data management. In some examples, a back-end system can be provided as an off-premises system (e.g., cloud or on-demand) that is operated by an enterprise or a third-party on behalf of an enterprise.

In some examples, the computing devices 102 and 104 each include computer-executable applications executed thereon. In some examples, the computing devices 102 and 104 each include a web browser application executed thereon, which can be used to display one or more web pages of platform running applications. In some examples, each of the computing devices 102 and 104 can display one or more graphical user interfaces (GUIs) that enable the respective users 110 and 112 to interact with the computing platform. In accordance with implementations of the present disclosure, the back-end systems 106 may host enterprise applications or systems that require data sharing and data privacy. In some examples, the computing device 102 and/or the computing device 104 can communicate with the back-end systems 106 over the network 108.

In some implementations, at least one of the back-end systems 106 can be implemented in a cloud environment that includes at least one server system 114. In the example of FIG. 1, the back-end server 106 can represent various forms of servers including, but not limited to, a web server, an application server, a proxy server, a network server, and/or a server pool. In general, server systems accept requests for application services and provide such services to any number of client devices (for example, the computing device 102 over the network 108).

In some implementations, the back-end system 106 can be used to implement an Artificial Intelligence (AI)-enabled platform trained to generate content relevant for individuals in accordance with contextual information and training data indicative of reactions of similar consenting individuals to certain content items (e.g., neuroscience responses). The AI-enabled platform can include a trained generative AI model that generates such personalized content. The generative AI model can be trained using a training corpus that combines data representing, for example, neuroscience responses of the individuals to stimuli triggered by various content items and corresponding context data acquired from a plurality of sources.

Various examples depicting generating an application programming interface (API), are described in detail in conjunctions with figures below.

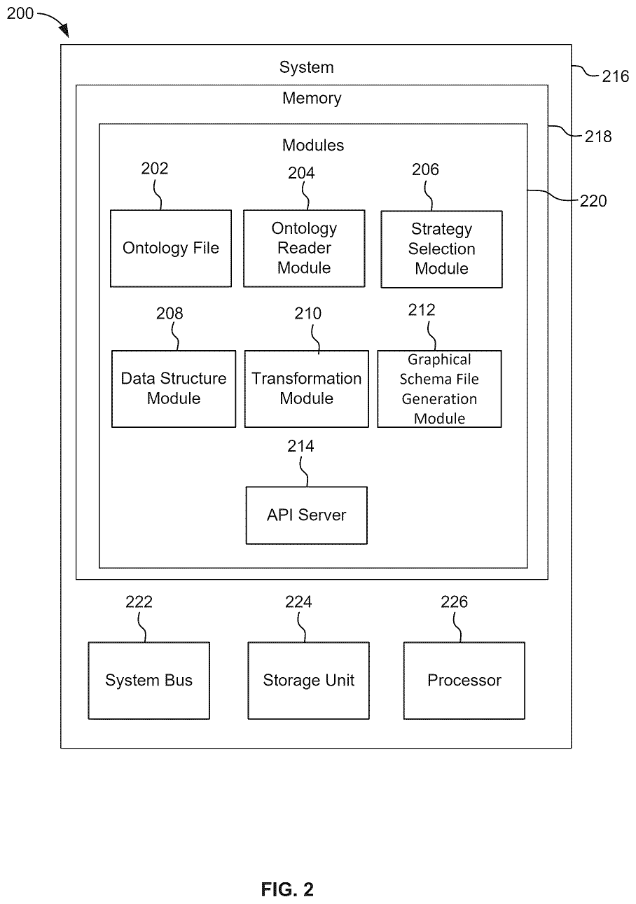

FIG. 2 illustrates an example of a system architecture 200 for generating an application programming interface (API) schema, in accordance with implementations of the present disclosure. The system 216 may also function as a computer-implemented system. The system 216 may include the one or more processors 226, the memory 218, and a storage unit 224. The one or more processors 226, the memory 218, and the storage unit 224 are communicatively coupled through a system bus 222 or any similar mechanism. The memory 218 includes the plurality of modules 220 in the form of programmable instructions executable by the one or more processors 226. The memory 218 can be a non-transitory memory storing instructions programmed to cooperate with the plurality of processors 226 to perform operations Moreover, the plurality of modules 220 may further include an ontology file 202, an ontology reader module 204, a strategy selection module 206, a data structure module 208, a transformation module 210, a graphical schema file generation module 212 and an API server 214.

The system 216 may receive the ontology file 202. Specifically, the ontology file 202 may include a set of API requirements by the user, describing the functionality of the required API. Herein, the functionality may include the types of data to be handled and the operations to be supported. Further, the system may receive the ontology file 202. The ontology file 202 can be a structured document, defining the schema of the underlying data in the set of API requirements provided by the user, in the knowledge graph. The ontology file 202 may further include definitions of classes (entities) and properties (attributes and relationships) that describe the data.

In an example, the structure of the ontology file 202 may be expressed as below. Specifically, the below expressed example of the ontology file 202 may include the entities (for example user, project and task), attributes (for example id, name, email, role, description, startDate, endDate, ownerId, status, assigneeId, projectId and dueDate), and relationships involved, for instance, in a project management system, defining the structure of the data, the API endpoints, and the expected requests and responses for interacting with the system.

### User

id: A unique identifier for each user.
name: The full name of the user.
email: The email address of the user.
role: The role of the user within the project management system.

### Project

id: A unique identifier for each project.
name: The name of the project.
description: A brief description of the project.
startDate: The date when the project starts.
endDate: The date when the project is expected to be completed.
ownerId: The unique identifier of the user who owns the project.

### Task

id: A unique identifier for each task.
title: The title of the task.
description: A brief description of the task.
status: The current status of the task.
assigneeId: The unique identifier of the user assigned to the task.
projectId: The unique identifier of the project to which the task belongs.
dueDate: The date by which the task should be completed.

### Endpoints

List Users: Retrieve a list of all users in the system.
Get User Details: Retrieve detailed information about a specific user.
Create User: Add a new user to the system.
Update User: Modify the details of an existing user.
List Projects: Retrieve a list of all projects in the system.
Get Project Details: Retrieve detailed information about a specific project.
List Tasks: Retrieve a list of all tasks in the system.
Get Task Details: Retrieve detailed information about a specific task.
Create Task: Add a new task to the system.
Update Task: Modify the details of an existing task.
Delete Task: Remove a task from the system.

### Supported Requests and Responses

Retrieve Information
Request: No body required.
Response: A JSON array of objects representing the requested information (e.g., list of users, projects, or tasks).

### Add New Information

Request: A JSON object containing the details of the new entity to be added (e.g., new user, project, or task).
Response: A JSON object of the newly created entity with a status code indicating successful creation.

### Modify Existing Information

Request: A JSON object containing the updated details of the entity.
Response: A JSON object of the updated entity with a status code indicating successful modification.

### Remove Information

Request: No body required.
Response: A status code indicating successful deletion of the entity.

In further detail, the ontology file 202 may include a domain-specific conceptual model. The domain-specific conceptual model may include ontological entities and corresponding relationship between ontological entities. Specifically, the ontological entities may include fundamental units of knowledge within the domain, representing concepts, objects, or individuals. The corresponding relationship between ontological entities may include logical connections or associations between the ontological entities, defining their interactions or dependencies. The ontological entities may include ontological data constructs, wherein the ontological data constructs may include a plurality of ontological types including at least one of a class, a data property, an object property, an axiom, and a comment. Moreover, the ontology file 202 provide a shared vocabulary for a domain, enabling the exchange of knowledge and fostering the development of interoperable systems. The ontology file 202 may be received by the system in a specific format such as RDF (Resource Description Framework), OWL (Web Ontology Language), XML (Extensible Markup Language) or the like, thereby providing a standardized and machine-readable format. By processing the ontology file 202, the system may gain a structured understanding of the domain, enabling subsequent operations such as reasoning, inference, and knowledge-based decision making.

In further detail, the received ontology file 202 may be accessed by the ontology reader module 204 for further processing. Specifically, the ontology reader module 204 may parse the ontology file 202 to identify elements including, but not limited to, tokens, keywords, and grammar rules adhering to the ontology file 202 language (e.g., OWL, RDF, XML). Furthermore, the elements are processed according to the ontology language's semantics to extract the meaning of the ontology. The processing may include identifying the relationships between the ontological entities and their properties. Specifically, the data structure module 208 (described in detail in further paragraphs) may processes the ontology file 202, by loading its contents into predefined data structures which are specifically designed for managing ontological objects. In essence, the ontology reader module 204 may parse the ontology file 202 by breaking it down into tokens, identifying keywords, analyzing grammar rules, extracting the semantic meaning of the elements, and identifying the relationships between entities and their properties.

In an example, the ontology file 202 (for example in OWL language) may define a class (for example, “person”) with properties (for example “name” and “age”). The ontology reader module 204 may parse the ontology file 202 and extract the information including entities, properties, and relationships (for example “person has the properties name and age”).

Thereafter, the strategy selection module 206 may determine a schema generation strategy based on the user requirement and the received ontology file 202. The schema generation strategy may include at least one of a simple strategy, a nearest neighbor strategy, and a shortest path strategy.

Specifically, an artificial intelligence (AI) inference model (although not depicted in FIG. 2) may determine the schema generation strategy. The AI inference model (for example Large Language Model (LLM)) may processes the free text API requirements. The AI inference model may utilize machine learning techniques, for example natural language processing (NLP), to interpret the user's intent and extract relevant information. Further, the AI inference model may identify an optimal subset of entities, for example “classes” and “properties” from the ontology file 202 that are necessary to fulfill the API requirements. Identifying the optimal subset of entities may include identifying relevant “classes” and “properties” that match the user's requirements and determining the relevant relationships between the identified “classes” and “properties”. Thus, the AI inference model may determine the schema generation strategy while minimizing the number of entities (“classes” and “properties”) required to fulfill the API requirements. Moreover, a consistency may be maintained by including the entities from the ontology file 202, that are required from the user's requirements.

Furthermore, the data structure module 208 may generate an ontological data structure for the received ontology file 202 based on the determined schema generation strategy (by the strategy selection module 206). Specifically, the ontological data structure may include the ontological entities mapped to a plurality of ontological classes in a predefined manner based on the relationship between the ontological entities and based on properties associated with the ontological entities. The mapping between ontological entities and the plurality of ontological classes may be performed systematically based on predefined rules that consider both the semantic relationships between ontological entities and their associated properties.

In further detail the data structure module 208 may processes the ontology file 202, by loading its contents into predefined data structures which are specifically designed for managing ontological objects. The ontological data structures implement standard ontological constructs, encompassing ontological types such as “Class”, “Data Property”, “Object Property”, “Axiom”, “Comment”, and others. Moreover, predefined mapping rules are utilized, that map each ontology object into an instance of corresponding ontological data structure, while maintaining relationships between the different objects. By retaining the content of the parsed ontology file in such a manner, these data structures effectively preserve the semantics of an ontology.

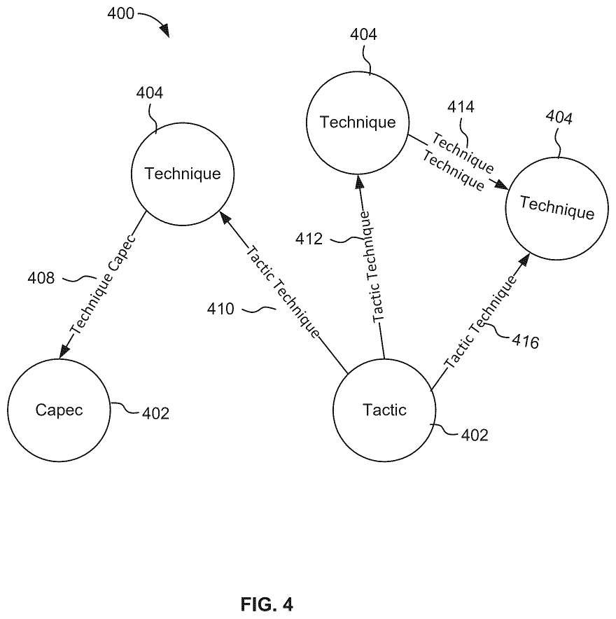

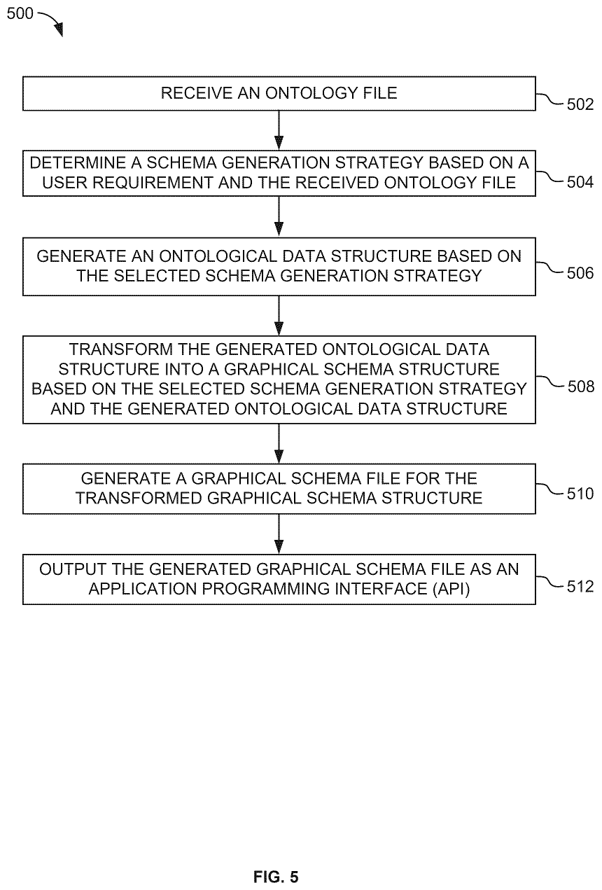

Moreover, the transformation module 210 may transform the generated ontological data structure into a graphical schema structure (described further in FIG. 4 and FIG. 5) by mapping each of the ontological entities to corresponding graphical entities based on the selected schema generation strategy and the generated ontological data structure. Specifically, the transformation module 210 may perform one of a one-to-one mapping between a property of an ontological entity with a graphical data property, and a one-to-plurality mapping between the property of the ontological entity with a plurality of graphical data properties.

Furthermore, the mapping of the ontological entities to corresponding graphical entities may define a procedural approach. The core components of the mapping strategy may include entity mapping, relationship mapping and aggregation mapping. Specifically, the entity mapping may include the correlation between ontology classes and API schema elements (e.g., resources, data models). The relationship mapping may define how the properties associated with the ontological entities are represented within the API schema (e.g., resource relationships, data model attributes). Moreover, the aggregation mapping may determine the consolidation of multiple ontology elements into a single API schema component (e.g., nested resources, complex data types).

In further detail, if the strategy selection module 206 determines the schema generation strategy to be the simple strategy, the plurality of ontological classes can be mapped to the corresponding graphical entities, wherein the graphical entities comprise a type entity. Further, each of the properties associated with the plurality of ontological classes can be mapped to a field of the corresponding graphical entities, wherein the field is mapped to at least one of graphical scalar types. Thereafter, a cardinality restriction value of the properties associated with the plurality of ontological classes can be mapped to a corresponding graphical object type selected from one of a nullable type, a non-nullable type, and a non-nullable array type. Specifically, the cardinality restrictions define the number of instances of a related class that a given instance can have. Furthermore, the nullable type may refer to a data type that can hold a value or be explicitly set to null. For example, in a database, a “middle_name” column might be nullable, allowing for records where a middle name is not provided. The non-nullable type may be a data type that must always have a value assigned to it. For example, in a database, a “first_name” column would typically be non-nullable, as it's essential for identifying a person. Further, the non-nullable array type may be an array that must contain at least one element. Each element within the array cannot be null. For instance, the non-nullable array type may be used when a collection of items is expected, and at least one item must be present (e.g., a list of products in an order).

Consequently, the graphical schema structure may be generated for the ontological data structure based on the mapping of the ontological entities to corresponding graphical entities by the transformation module 210.

Moreover, if the strategy selection module 206 determines the schema generation strategy to be the nearest neighbor strategy, each of the plurality of ontological classes can be mapped to the corresponding graphical entities based on the selected schema generation strategy, wherein the graphical entities comprise a type entity. Furthermore, each of the properties associated with the plurality of ontological classes can be mapped to a field of the corresponding graphical entities, wherein the field is mapped to a type corresponding to a target graphical class. Thereafter, map the cardinality restriction value of the properties associated with the plurality of ontological classes can be mapped to a corresponding graphical object type selected from one of a nullable type, a non-nullable type, and a non-nullable array type.

Further, at least one relationship between each node in the plurality of ontological classes may be determined, based on the mapped properties associated with the plurality of ontological classes, the mapped graphical object type, and the cardinality restriction value. Additionally, at least one nearest neighbor node may be determined for each node based on the determined at least one relationship. Moreover, a path may be determined connecting each node with the determined at least one nearest neighbor node. Consequently, the graphical schema structure may be generated for the ontological data structure based on the determined path, and the determined at least one nearest neighbor node. Herein, the graphical schema structure represents a knowledge graph representation of each node connected to at least one nearest neighbor node using the determined path.

Moreover, if the strategy selection module 206 determines the schema generation strategy to be the shortest path strategy, the plurality of ontological classes in the generated ontological data structure may be mapped to corresponding graphical data types. Further, the properties associated with the ontological entities may be mapped to scalar fields in the corresponding graphical data types. The related properties for each class in the ontology file may be identified using a shortest path graph traversal technique.

Furthermore, a plurality of shortest paths connecting the plurality of ontological classes may be identified based on the identified implicitly related properties for each class. The plurality of shortest paths may be identified by determining a plurality of paths connecting between the plurality of ontological classes and prioritizing the shortest paths comprising least connections between the plurality of ontological classes. Additionally, an inferred object property may be assigned to the ontology data structure for each of the identified plurality of shortest paths. Herein, the inferred object property represents an implicit relationship between the plurality of ontological classes. Moreover, the inferred object property may be mapped to a corresponding field in the graphical schema structure of a first class type. Thereafter, the cardinality restriction value may be calculated for the inferred object property based on cardinality restrictions of the properties associated with the ontological entities and the identified plurality of shortest paths. Further, the calculated cardinality restriction value may be mapped to a corresponding graphical object type selected from one of a nullable type, a non-nullable type, and a non-nullable array type. Consequently, the graphical schema structure may be generated for the ontological data structure based on the mapping.

In further detail, the graphical schema file generation module 212 may generate a graphical schema file for the transformed graphical schema structure by serializing the transformed graphical schema structure. Specifically, the graphical schema structure may be serialized and inscribed into a standard API schema text file, based on selected API style. The non-limiting example of the standard API schema text file may include GraphQL schema (for GraphQL API), OpenAPI spec (for REST API), and WSDL (for SOAP API). The API schema text file describes the API that can then be served using the API server 214 runtime.

Furthermore, the API server 214 may output the generated graphical schema file as an application programming interface (API). Specifically, upon successful generation, the graphical schema file serves as a foundation for generating the API. The generation of API may include transforming the graphical schema file into a functional service capable of handling incoming requests and producing corresponding responses. Moreover, the API server may process incoming requests and formulate corresponding responses, drawing data from an underlying knowledge graph. The graphical schema file may provide the necessary structure for defining endpoints, request/response formats, and data models, ensuring alignment between the API interface and the knowledge graph's representation. By adhering to the graphical schema file, the API server 214 may optimizes request handling, data retrieval, and response generation, facilitating seamless interaction between clients and the knowledge graph.

For instance, to implement the logic of CRUD (Create, Read, Update, Delete) operations on a database given based on a schema file, a plurality of frameworks and tools may be utilized. Herein, CRUD may refer to a fundamental set of operations, used in database management and software development to interact with data. The frameworks and tools may connect to a predefined data source (for example databases, like SQL server, PostgreSQL, Neo4j, MongoDB etc.) for fetching data or modifying it. Based on the type of data source, plurality of frameworks and tools may automatically create the implementation of the logic for CRUD operations on the data source, for each table or database instance in the data source. Thereafter, users may fetch data (queries) and modify data (mutations) without writing any code.

Is an example, there may be a database with a single table called “users” including the columns: id (integer), name (string), email (string). Considering, generation of the API schema for GraphQL, the API schema may be expressed as:
“″”
type User {
   id: Int!
   name: String!
   email: String!
}
type Query {
   users: [User!]!
}
   and a query may be expressed as:
“″”
query {
   users {
      id
      name
      email
   }
}
“″”

On the execution of the above GraphQL query, the GraphQL query may translate into a SQL query to fetch the data from the database. The resulting SQL query may be expressed as:
SELECT id, name, email FROM users;
   The resulting SQL query may transformed to, for example, a JSON data structure corresponding to the user's request.

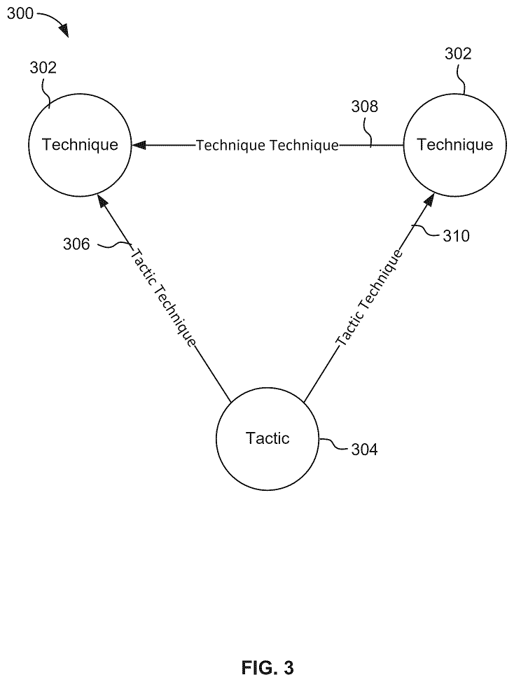

FIG. 3 illustrates an exemplary structure of the graphical schema structure based on the schema generation strategy to be the nearest neighbor strategy, in accordance with implementations of the present disclosure.

In the example, the transformation module 210 may transform the ontological data structure into the graphical schema structure 300, including nodes and edges. Specifically, the graphical schema structure 300 may be a knowledge graph representation of each node connected to at least one nearest neighbor node. Herein the ontological data structure may include ontological entities mapped to the plurality of ontological classes. Moreover, each ontological class is represented by a node in the graph. The nodes are assigned properties and attributes. The edges are used to connect nodes and represent the extracted relationships. For example, in the graphical schema structure 300, the ontological classes “technique” 302 and “tactic” 304. The edges 306, 308 and 310 represent the relationships between “technique” 302 and “tactic” 304 nodes.

In the example, the “tactic” 304 node is positioned centrally, and the “technique” 302 nodes are placed around it, indicating their closest relationship to the tactic. Herein, the “technique” 302 and “tactic” 304 nodes may represent the ontological classes. Each of the plurality of ontological classes (the “technique” 302 and “tactic” 304) may mapped to the corresponding graphical entities based on the selected schema generation strategy. Herein the graphical entities may include a type entity. Furthermore, a cardinality restriction value of the properties associated with the plurality of ontological classes (the “technique” 302 and “tactic” 304) may be mapped to a corresponding graphical object type selected from one of a nullable type, a non-nullable type, and a non-nullable array type. Specifically, the cardinality restrictions define the number of instances of a related class that a given instance can have. For instance, considering an example of an ontology of books and authors, a “Book” entity may have a property “author” with a cardinality restriction of “1 or more” (non-nullable array type). In the graphical schema structure, this may be represented as a “Book” node connected to multiple “Author” nodes by a solid line, indicating that each book must have at least one author. The mapping of the cardinality restriction value of the properties associated with the plurality of ontological classes (the “technique” 302 and “tactic” 304) may prevent inconsistencies in data entry or modeling.

Furthermore, the nullable type may refer to a data type that can hold a value or be explicitly set to null. For example, in a database, a “middle_name” column might be nullable, allowing for records where a middle name is not provided. The non-nullable type may be a data type that must always have a value assigned to it. For example, in a database, a “first_name” column would typically be non-nullable, as it's essential for identifying a person. Further, the non-nullable array type may be an array that must contain at least one element. Each element within the array cannot be null. For instance, the non-nullable array type may be used when a collection of items is expected, and at least one item must be present (e.g., a list of products in an order).

Moreover, at least one relationship between each node in the plurality of ontological classes (the “technique” 302 and “tactic” 304) may be determined based on the mapped properties associated with the plurality of ontological classes (the “technique” 302 and “tactic” 304), the mapped graphical object type, and the cardinality restriction value. Specifically, for each property linked to the ontological class, the system determines the property's domain (the class it originates from) and range (the class it points to). Further, the graphical object type associated with the property identifies the nature of the relationship. For instance, a non-nullable array type suggests a one-to-many relationship, while a non-nullable type often indicates a one-to-one relationship. Furthermore, the cardinality restriction value specifies the minimum and maximum number of instances of the range class that can be associated with an instance of the domain class, thereby refining the relationship type. By combining information from properties, types, and the cardinality restriction value, the system can establish relationships between ontological classes, forming the foundation of the knowledge graph representation.

FIG. 4 illustrates an exemplary structure the graphical schema structure based on the schema generation strategy to be the shortest path strategy, in accordance with implementations of the present disclosure.

In an example, the plurality of ontological classes “capec” 402, “technique” 404 and “tactic” 406 in the generated ontological data structure may be mapped to corresponding graphical data types. Further, the properties associated with the ontological entities may be mapped to scalar fields in the corresponding graphical data types. The related properties for each class “capec” 402, “technique” 404 and “tactic” 406 in the ontology file may be identified implicitly using a shortest path graph traversal technique.

Moreover, a plurality of shortest paths may be identified connecting the plurality of ontological classes “capec” 402, “technique” 404 and “tactic” 406, based on the identified implicitly related properties for each class. Herein the plurality of shortest paths may be identified by determining a plurality of paths 408, 410, 412, 414 and 416 connecting between the plurality of ontological classes “capec” 402, “technique” 404 and “tactic” 406 and prioritizing the shortest paths comprising least connections between the plurality of ontological classes.

Further, an inferred object property may be assigned to the ontology data structure for each of the identified plurality of shortest paths. The inferred object property represents an implicit relationship between the plurality of ontological classes “capec” 402, “technique” 404 and “tactic” 406. Thereafter, map the inferred object property may be mapped to a corresponding field in the graphical schema structure 400 of a first class type.

Furthermore, a cardinality restriction value for the inferred object property may be calculated based on cardinality restrictions of the properties associated with the ontological entities and the identified plurality of shortest paths. The calculated cardinality restriction value may be mapped to a corresponding graphical object type selected from one of a nullable type, a non-nullable type, and a non-nullable array type. Consequently, the graphical schema structure 400 may generated for the ontological data structure based on the mapping.

FIG. 5 illustrates the flow diagram of an example method 500 for generating application programming interface (API) schema, in accordance with implementations of the present disclosure. In some implementations, the method 500 may be executed within the system for application programming interface (API) schema as described in relation to FIG. 2.

At step 502, the method 500 may include, receiving the ontology file 202 comprising a domain-specific conceptual model. The domain-specific conceptual model comprises ontological entities and corresponding relationship between ontological entities.

At step 504, the method 500 may include, determining the schema generation strategy. Specifically, the strategy selection module 206 may determine the schema generation strategy from at least one of a simple strategy, a nearest neighbor strategy, and a shortest path strategy for the received ontology file 202 based on the user requirement and the received ontology file 202.

At step 506, the method 500, may include generating the ontological data structure for the received ontology file 202 based on the determined schema generation strategy. Specifically, the data structure module 208 may generate the ontological data structure. Moreover, the ontological data structure may include the ontological entities mapped to the plurality of ontological classes in a predefined manner based on the relationship between the ontological entities and based on properties associated with the ontological entities.

At step 508, the method 500, may include transforming the generated ontological data structure into the graphical schema structure by mapping each of the ontological entities to corresponding graphical entities based on the selected schema generation strategy and the generated ontological data structure at step 506. Specifically, the transformation module 210 generated the graphical schema structure.

At step 510, the method 500, may include generating the graphical schema file for the transformed graphical schema structure by serializing the transformed graphical schema structure. Specifically, graphical schema file generation module 212 may generate the graphical schema file.

Herein, the serialization may include converting the in-memory representation of the graphical schema structure into a sequence of bytes that can be written to a file or transmitted over a network. The serialized data can then be deserialized back into its original form when required.

At step 512, the method 500 may include output the generated graphical schema file as the application programming interface (API) by API server 214. Specifically, the application programming interface (API) may be accessible to other applications or systems. Further, the API server 214 may act as an intermediary, receiving requests from users, generating the graphical schema, and returning it in a specified format.

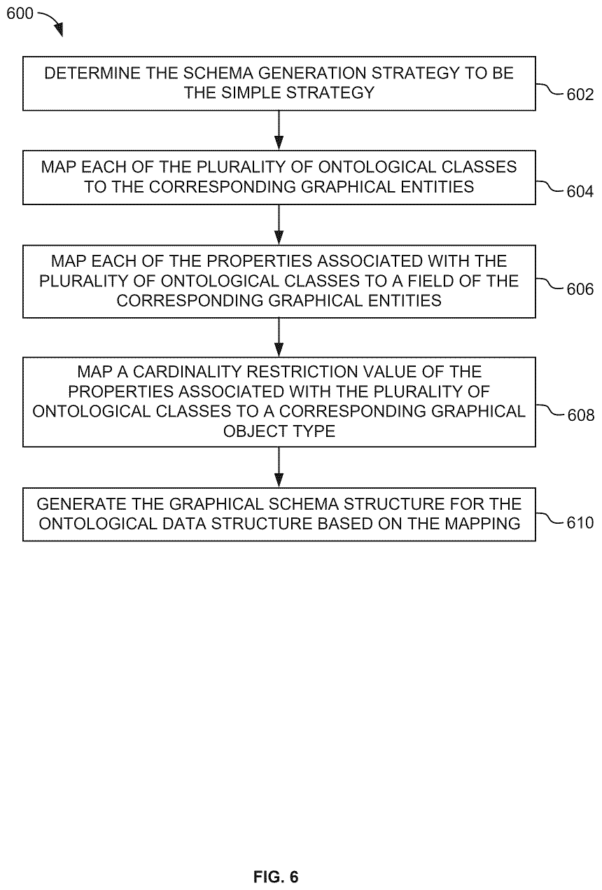

FIG. 6 illustrates the flow diagram of an example method 600 for transforming the generated ontological data structure into the graphical schema structure based on the schema generation strategy to be the simple strategy, in accordance with implementations of the present disclosure. In some implementations, the method 700 may be executed within the system 216, as described in relation to FIG. 2.

At step 602, the method 600 may include determining the schema generation strategy to be the simple strategy. Specifically, the strategy selection module 206 may select the simple strategy based on the user requirement and the received ontology file 202.

At step 604, the method 600 may include mapping each of the plurality of ontological classes to the corresponding graphical entities based on the selected schema generation strategy. Herein the graphical entities may include a type entity. Specifically, by mapping the plurality ontological classes to corresponding graphical data types, the system 216 may establish the groundwork for creating a visually comprehensible representation of the ontological knowledge.

At step 606, the method 600 may include mapping each of the properties associated with the plurality of ontological classes to a field of the corresponding graphical entities. Specifically, the field may be mapped to at least one of graphical scalar type.

At step 608, the method 600 may include mapping the cardinality restriction value of the properties associated with the plurality of ontological classes to a corresponding graphical object type. Specifically, the cardinality restriction value may be selected from one of, but not limited to, a nullable type, a non-nullable type, and a non-nullable array type.

At step 610, the method 600 may include generating the graphical schema structure for the ontological data structure based on the mapping.

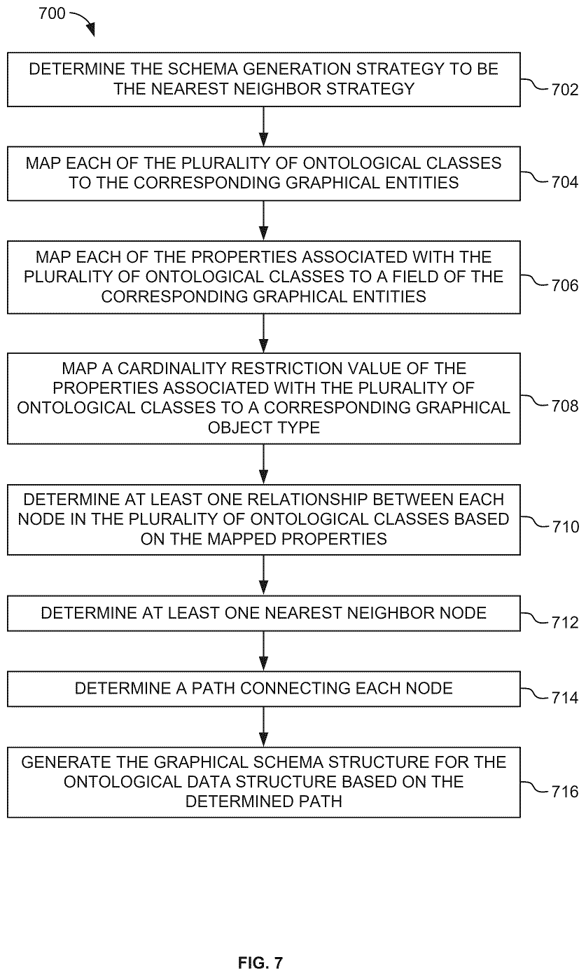

FIG. 7 illustrates the flow diagram of an example method 700 for transforming the generated ontological data structure into the graphical schema structure based on the schema generation strategy to be the nearest neighbor strategy, in accordance with implementations of the present disclosure. In some implementations, the method 700 may be executed within the system 216, as described in relation to FIG. 2.

At step 702, the method 700 may include determining the schema generation strategy to be the nearest neighbor strategy. Specifically, the strategy selection module 206 may select the nearest neighbor strategy based on the user requirement and the received ontology file 202.

At step 704, the method 700 may include mapping each of the plurality of ontological classes to the corresponding graphical entities based on the selected schema generation strategy. Herein, the graphical entities may include a type entity. Specifically, by mapping the plurality ontological classes to corresponding graphical data types, the system 216 may establish the groundwork for creating a visually comprehensible representation of the ontological knowledge.

At step 706, the method 700 may include mapping each of the properties associated with the plurality of ontological classes to a field of the corresponding graphical entities. Specifically, the field may be mapped to a type corresponding to a target graphical class.

At step 708, the method 700 may include mapping a cardinality restriction value of the properties associated with the plurality of ontological classes to a corresponding graphical object type. Specifically, the cardinality restriction value may be selected from one of, but not limited to, a nullable type, a non-nullable type, and a non-nullable array type.

At step 710, the method 700 may include determining at least one relationship between each node in the plurality of ontological classes based on the mapped properties associated with the plurality of ontological classes, the mapped graphical object type, and the cardinality restriction value.

At step 712, the method 700 may include determining at least one nearest neighbor node for each node based on the determined at least one relationship. Moreover, determining at least one nearest neighbor node for each node, may be based on a distance metric (for example, Euclidean distance, network hops, or the like).

At step 714, the method 700 may include determining the path connecting each node with the determined at least one nearest neighbor node. Specifically, a route or sequence of connections that connects each node to its nearest neighbor(s) may be calculated. The calculation may include graph traversal technique (e.g., Dijkstra's technique, breadth-first search) to determine the path.

At step 716, the method 700 may include generating the graphical schema structure for the ontological data structure based on the determined path, and the determined at least one nearest neighbor node. Specifically, the graphical schema structure may represent a knowledge graph representation of each node connected to at least one nearest neighbor node using the determined path.

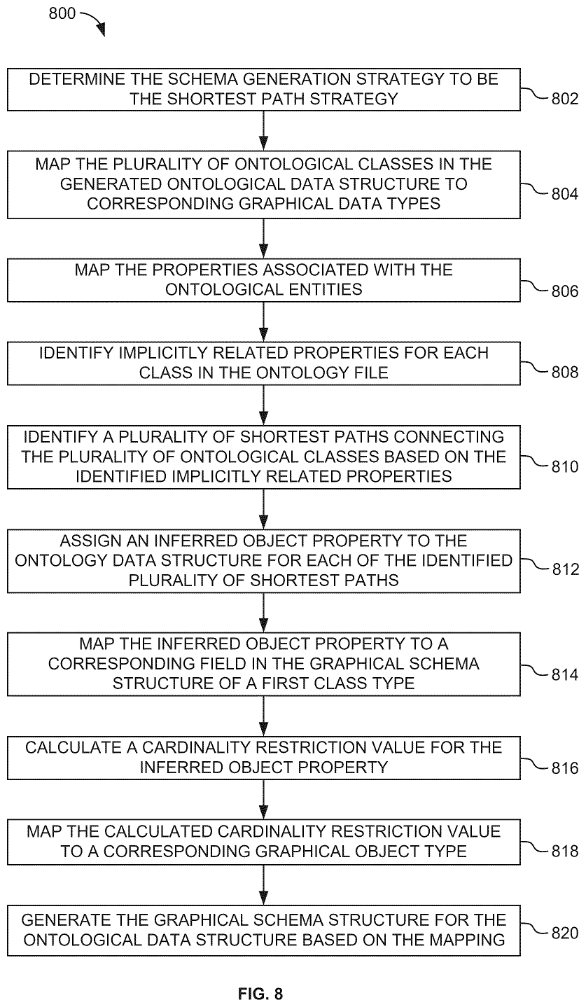

FIG. 8 illustrates the flow diagram of an example method 800 for transforming the generated ontological data structure into the graphical schema structure based on the schema generation strategy to be the shortest path strategy, in accordance with implementations of the present disclosure. In some implementations, the method 800 may be executed within the system 216, as described in relation to FIG. 2.

At step 802, the method 800 may include determining the schema generation strategy to be the shortest path strategy. Specifically, the strategy selection module 206 may select the shortest path strategy based on the user requirement and the received ontology file 202.

At step 804, the method 800 may include mapping the plurality of ontological classes in the generated ontological data structure to corresponding graphical data types. Specifically, by mapping the plurality ontological classes to corresponding graphical data types, the system 216 may establish the groundwork for creating a visually comprehensible representation of the ontological knowledge.

At step 806, the method 800 may include mapping the properties associated with the ontological entities to scalar fields in the corresponding graphical data types. The scalar fields may include, but not limited to strings, numbers, Booleans, or the like.

At step 808, the method 800 may include identifying implicitly related properties for each class in the ontology file 202 using a shortest path graph traversal technique. The shortest path graph traversal can be a technique used to find the most efficient route between two nodes in a graph.

At step 810, the method 800 may include identifying the plurality of shortest paths connecting the plurality of ontological classes based on the identified implicitly related properties for each class. Specifically, the plurality of shortest paths may be identified by determining a plurality of paths connecting between the plurality of ontological classes and prioritizing the shortest paths comprising least connections between the plurality of ontological classes.

At step 812, the method 800 may include assigning the inferred object property to the ontology data structure for each of the identified plurality of shortest paths. Specifically, the inferred object property may represent an implicit relationship between the plurality of ontological classes.

At step 814, the method 800 may include mapping the inferred object property to a corresponding field in the graphical schema structure of a first class type. Specifically, the mapping may serves as a bridge between the conceptual representation of the inferred object property and its concrete implementation as the corresponding field in the graphical schema structure, thereby ensuring that the semantic relationships are defined and reflected in the underlying data.

At step 816, the method 800 may include calculating a cardinality restriction value for the inferred object property based on cardinality restrictions of the properties associated with the ontological entities and the identified plurality of shortest paths.

At step 818, the method 800 may include mapping the calculated cardinality restriction value to a corresponding graphical object type. Specifically, the cardinality restriction value may be selected from one of, but not limited to, a nullable type, a non-nullable type, and a non-nullable array type.

At step 820, the method 800 may include generating the graphical schema structure for the ontological data structure based on the mapping. Specifically, the graphical schema may provide a visual aid for understanding the relationships and hierarchies within the ontology.

Implementations of the present disclosure provides novel approach for generating APIs for knowledge graphs. The present disclosure discloses creating a graphical schema file from a conceptual model described by an ontology. Further, the present solution leverages ontological constructs to define the software models and the relationships between them. In the present disclosure, by selecting the schema generation strategy (at least one of a simple strategy, a nearest neighbor strategy, and a shortest path strategy) specifically implemented for querying graphical data sources. By implementing the ontology driven API schema generation, an API schema can be generated semi automatically with minimal user interaction. Thus, the delivery lead time and deployment frequency can be optimized. The delivery lead time is the time it takes to go from a customer making a product request to the request being satisfied. The delivery is focused, without the requirement of design and validation (the time it takes for work to be implemented, tested, and delivered).

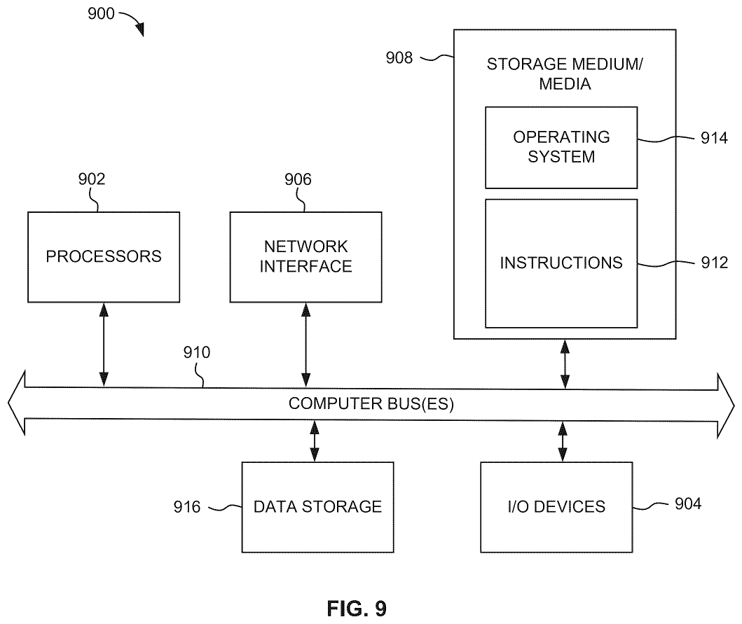

FIG. 9 illustrates a computer system 900 that may be used to implement the system to generate the graphical schema as the application programming interface (API). More particularly, computing machines such as desktops, laptops, smartphones, tablets, and wearables which may be used to implement the tasks that may have the structure of the computer system 900. The computer system 900 may include additional components not shown and that some of the process components described may be removed and/or modified. In another example, a computer system 900 may be deployed on external-cloud platforms such as cloud, internal corporate cloud computing clusters, organizational computing resources, and/or the like.

The computer system 900 includes processor(s) 902, such as a central processing unit, application-specific integrated circuit (ASIC) or another type of processing circuit, input/output devices 904, such as a display, mouse keyboard, etc., a network interface 906, such as a Local Area Network (LAN), a wireless 802.11x LAN, a 3G or 4G mobile WAN or a WiMax WAN, and a computer-readable medium 908. Each of these components may be operatively coupled to a bus 1110. The computer-readable storage medium 908 may be any suitable medium that participates in providing instructions to the processor(s) 902 for execution. For example, the computer-readable storage medium 908 may be non-transitory or non-volatile medium, such as a magnetic disk or solid-state non-volatile memory or volatile medium such as random access memory (RAM). The instructions or modules stored on the computer-readable storage medium 908 may include machine-readable instructions 912 executed by the processor(s) 902 that cause the processor(s) 902 to perform the methods and functions of the system to generate the graphical schema as the application programming interface (API).

The system 216 may be implemented as software stored on a non-transitory processor-readable medium and executed by the processors 902. For example, the computer-readable storage medium 908 may store an operating system 914, such as MAC OS, MS WINDOWS, UNIX, or LINUX, and code for the system. The operating system 914 may be multi-user, multiprocessing, multitasking, multithreading, real-time, and the like. For example, during runtime, the operating system 914 is running and the code for the system is executed by the processor(s) 902.

The computer system 900 may include a data storage 916, which may include non-volatile data storage. The data storage 916 stores any data used or generated by the system.

The network interface 906 connects the computer system 900 to internal systems for example, via a LAN. Also, the network interface 906 may connect the computer system 900 to the Internet. For example, the computer system 900 may connect to web browsers and other external applications and systems via the network interface 906.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an application specific integrated circuit (ASIC).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touchpad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A system comprising:
a processor; and
a memory communicably coupled to the processor, wherein the memory comprises processor-executable instructions which, when executed by the processor, cause the processor to:
receive an ontology file comprising a domain-specific conceptual model, wherein the domain-specific conceptual model comprises ontological entities and corresponding relationship between ontological entities;
determine a schema generation strategy from at least one of a simple strategy, a nearest neighbor strategy, and a shortest path strategy for the received ontology file based on a user requirement and the received ontology file;
generate an ontological data structure for the received ontology file based on the determined schema generation strategy, wherein the ontological data structure comprises the ontological entities mapped to a plurality of ontological classes in a predefined manner based on the relationship between the ontological entities and based on properties associated with the ontological entities;
transform the generated ontological data structure into a graphical schema structure by mapping each of the ontological entities to corresponding graphical entities based on the selected schema generation strategy and the generated ontological data structure;
generate a graphical schema file for the transformed graphical schema structure by serializing the transformed graphical schema structure; and
output the generated graphical schema file as an Application Programming Interface (API).

2. The system of claim 1, wherein the ontological entities comprises ontological data constructs, wherein the ontological data constructs comprise a plurality of ontological types comprising at least one of a class, a data property, an object property, an axiom, and a comment.

3. The system of claim 1, wherein to transform the generated ontological data structure into the graphical schema structure by mapping each of the ontological entities to the corresponding graphical entities based on the selected schema generation strategy and the generated ontological data structure, the processor is configured to:
perform one of a one-to-one mapping between a property of an ontological entity with a graphical data property, and a one-to-plurality mapping between the property of the ontological entity with a plurality of graphical data properties.

4. The system of claim 1, wherein to transform the generated ontological data structure into the graphical schema structure, the processor is configured to:
determine the schema generation strategy to be the simple strategy;
map each of the plurality of ontological classes to the corresponding graphical entities based on the selected schema generation strategy, wherein the graphical entities comprise a type entity;
map each of the properties associated with the plurality of ontological classes to a field of the corresponding graphical entities, wherein the field is mapped to at least one of graphical scalar types;
map a cardinality restriction value of the properties associated with the plurality of ontological classes to a corresponding graphical object type selected from one of a nullable type, a non-nullable type, and a non-nullable array type; and
generate the graphical schema structure for the ontological data structure based on the mapping.

5. The system of claim 1, wherein to transform the generated ontological data structure into the graphical schema structure, the processor is configured to:
determine the schema generation strategy to be the nearest neighbor strategy;
map each of the plurality of ontological classes to the corresponding graphical entities based on the selected schema generation strategy, wherein the graphical entities comprise a type entity;
map each of the properties associated with the plurality of ontological classes to a field of the corresponding graphical entities, wherein the field is mapped to a type corresponding to a target graphical class; and
map a cardinality restriction value of the properties associated with the plurality of ontological classes to a corresponding graphical object type selected from one of a nullable type, a non-nullable type, and a non-nullable array type;
determine at least one relationship between each node in the plurality of ontological classes based on the mapped properties associated with the plurality of ontological classes, the mapped graphical object type, and the cardinality restriction value;
determine at least one nearest neighbor node for each node based on the determined at least one relationship;
determine a path connecting each node with the determined at least one nearest neighbor node; and
generate the graphical schema structure for the ontological data structure based on the determined path, and the determined at least one nearest neighbor node, wherein the graphical schema structure represents a knowledge graph representation of each node connected to at least one nearest neighbor node using the determined path.

6. The system of claim 1, wherein to transform the generated ontological data structure into the graphical schema structure, the processor is configured to:
determine the schema generation strategy to be the shortest path strategy;
map the plurality of ontological classes in the generated ontological data structure to corresponding graphical data types;
map the properties associated with the ontological entities to scalar fields in the corresponding graphical data types;
identify implicitly related properties for each class in the ontology file using a shortest path graph traversal technique;
identify a plurality of shortest paths connecting the plurality of ontological classes based on the identified implicitly related properties for each class, wherein the plurality of shortest paths is identified by determining a plurality of paths connecting between the plurality of ontological classes and prioritizing the shortest paths comprising least connections between the plurality of ontological classes;
assign an inferred object property to the ontology data structure for each of the identified plurality of shortest paths, wherein the inferred object property represents an implicit relationship between the plurality of ontological classes;
map the inferred object property to a corresponding field in the graphical schema structure of a first class type;
calculate a cardinality restriction value for the inferred object property based on cardinality restrictions of the properties associated with the ontological entities and the identified plurality of shortest paths;
map the calculated cardinality restriction value to a corresponding graphical object type selected from one of a nullable type, a non-nullable type, and a non-nullable array type; and
generate the graphical schema structure for the ontological data structure based on the mapping.

7. The system of claim 6, wherein the processor is configured to:
select an any-to-any path as the schema generation strategy for each pair of the plurality of ontological classes;
determine a plurality of paths existing between each pair of the plurality of ontological classes using a graph traversal technique;
create a graphical type entity corresponding to the pair of the plurality of ontological classes;
create a graphical field entity for the created graphical type entity, wherein the graphical field entity comprises name of the pair of the plurality of classes and object properties traversed along the determined plurality of paths;
assign the determined plurality of paths and the pair of the plurality of ontological classes to corresponding created graphical field entity and the created graphical type entity; and
generate the graphical schema structure for the ontological data structure based on the assignment.

8. The system of claim 1, wherein the processor is configured to:
determine at least one modification made within the received ontology file by parsing the received ontology file;
generate an updated ontological data structure for the received ontology file based on the determined at least one modification;
transform the updated ontological data structure into an updated graphical schema structure based on the selected schema generation strategy; and
generate an updated graphical schema file for the updated graphical schema structure by serializing the updated graphical schema structure.

9. The system of claim 1, wherein to determine the schema generation strategy from at least one of the simple strategy, the nearest neighbor strategy, and the shortest path strategy for the received ontology file based on the user requirement, the processor is configured to:
receive a set of Application Programming Interface (API) requirements from a user;
process the set of API requirements by extracting a data syntax and a contextual intent of the set of API requirements;
select the schema generation strategy by applying the extracted data syntax and the contextual intent to a trained machine inference model; and
generate the graphical schema file based on the selected schema generation strategy.

10. A method comprising:
receiving, by a processor, an ontology file comprising a domain-specific conceptual model, wherein the domain-specific conceptual model comprises ontological entities and corresponding relationship between ontological entities;
determining, by the processor, a schema generation strategy from at least one of a simple strategy, a nearest neighbor strategy, and a shortest path strategy for the received ontology file based on a user requirement and the received ontology file;
generating, by the processor, an ontological data structure for the received ontology file based on the selected schema generation strategy, wherein the ontological data structure comprises the ontological entities mapped to a plurality of ontological classes in a predefined manner based on the relationship between the ontological entities and based on properties associated with the ontological entities;
transforming, by the processor, the generated ontological data structure into a graphical schema structure by mapping each of the ontological entities to corresponding graphical entities based on the selected schema generation strategy and the generated ontological data structure;
generating, by the processor, a graphical schema file for the transformed graphical schema structure by serializing the transformed graphical schema structure; and
outputting, by the processor, the generated graphical schema file as an Application Programming Interface (API).

11. The method of claim 10, wherein the ontological entities comprises ontological data constructs, wherein the ontological data constructs comprise a plurality of ontological types comprising at least one of a class, a data property, an object property, an axiom, and a comment.

12. The method of claim 10, wherein transforming the generated ontological data structure into the graphical schema structure by mapping each of the ontological entities to the corresponding graphical entities based on the selected schema generation strategy and the generated ontological data structure comprises:
performing, by the processor, one of a one-to-one mapping between a property of an ontological entity with a graphical data property, and a one-to-plurality mapping between the property of the ontological entity with a plurality of graphical data properties.

13. The method of claim 10, wherein transforming the generated ontological data structure into the graphical schema structure comprises:
determining, by the processor, the schema generation strategy to be the simple strategy;
mapping, by the processor, each of the plurality of ontological classes to the corresponding graphical entities based on the selected schema generation strategy, wherein the graphical entities comprise a type entity;
mapping, by the processor, each of the properties associated with the plurality of ontological classes to a field of the corresponding graphical entities, wherein the field is mapped to at least one of graphical scalar types;
mapping, by the processor, a cardinality restriction value of the properties associated with the plurality of ontological classes to a corresponding graphical object type selected from one of a nullable type, a non-nullable type, and a non-nullable array type; and
generating, by the processor, the graphical schema structure for the ontological data structure based on the mapping.

14. The method of claim 10, wherein transforming the generated ontological data structure into the graphical schema structure comprises:
determining, by the processor, the schema generation strategy to be the nearest neighbor strategy;
mapping, by the processor, each of the plurality of ontological classes to the corresponding graphical entities based on the selected schema generation strategy, wherein the graphical entities comprise a type entity;
mapping, by the processor, each of the properties associated with the plurality of ontological classes to a field of the corresponding graphical entities, wherein the field is mapped to a type corresponding to a target graphical class; and
mapping, by the processor, a cardinality restriction value of the properties associated with the plurality of ontological classes to a corresponding graphical object type selected from one of a nullable type, a non-nullable type, and a non-nullable array type;
determining, by the processor, at least one relationship between each node in the plurality of ontological classes based on the mapped properties associated with the plurality of ontological classes, the mapped graphical object type, and the cardinality restriction value;
determining, by the processor, at least one nearest neighbor node for each node based on the determined at least one relationship;
determining, by the processor, a path connecting each node with the determined at least one nearest neighbor node; and
generating, by the processor, the graphical schema structure for the ontological data structure based on the determined path, and the determined at least one nearest neighbor node, wherein the graphical schema structure represents a knowledge graph representation of each node connected to at least one nearest neighbor node using the determined path.

15. The method of claim 10, wherein transforming the generated ontological data structure into the graphical schema structure comprises:
determining, by the processor, the schema generation strategy to be the shortest path strategy;
mapping, by the processor, the plurality of ontological classes in the generated ontological data structure to corresponding graphical data types;
mapping, by the processor, the properties associated with the ontological entities to scalar fields in the corresponding graphical data types;
identifying, by the processor, implicitly related properties for each class in the ontology file using a shortest path graph traversal technique;
identifying, by the processor, a plurality of shortest paths connecting the plurality of ontological classes based on the identified implicitly related properties for each class, wherein the plurality of shortest paths is identified by determining a plurality of paths connecting between the plurality of ontological classes and prioritizing the shortest paths comprising least connections between the plurality of ontological classes;
assigning, by the processor, an inferred object property to the ontology data structure for each of the identified plurality of shortest paths, wherein the inferred object property represents an implicit relationship between the plurality of ontological classes;
mapping, by the processor, the inferred object property to a corresponding field in the graphical schema structure of a first class type;
calculating, by the processor, a cardinality restriction value for the inferred object property based on cardinality restrictions of the properties associated with the ontological entities and the identified plurality of shortest paths;
mapping, by the processor, the calculated cardinality restriction value to a corresponding graphical object type selected from one of a nullable type, a non-nullable type, and a non-nullable array type; and
generating, by the processor, the graphical schema structure for the ontological data structure based on the mapping.

16. The method of claim 15, further comprising:
selecting, by the processor, an any-to-any path as the schema generation strategy for each pair of the plurality of ontological classes;
determining, by the processor, a plurality of paths existing between each pair of the plurality of ontological classes using a graph traversal technique;
creating, by the processor, a graphical type entity corresponding to the pair of the plurality of ontological classes;
creating, by the processor, a graphical field entity for the created graphical type entity, wherein the graphical field entity comprises name of the pair of the plurality of classes and object properties traversed along the determined plurality of paths;
assigning, by the processor, the determined plurality of paths and the pair of the plurality of ontological classes to corresponding created graphical field entity and the created graphical type entity; and
generating, by the processor, the graphical schema structure for the ontological data structure based on the assignment.

17. The method of claim 10, further comprising:
determining, by the processor, at least one modification made within the received ontology file by parsing the received ontology file;
generating, by the processor, an updated ontological data structure for the received ontology file based on the determined at least one modification;
transforming, by the processor, the updated ontological data structure into an updated graphical schema structure based on the selected schema generation strategy; and
generating, by the processor, an updated graphical schema file for the updated graphical schema structure by serializing the updated graphical schema structure.

18. The method of claim 10, wherein determining the schema generation strategy from at least one of the simple strategy, the nearest neighbor strategy, and the shortest path strategy for the received ontology file based on the user requirement comprises:
receiving, by the processor, a set of application programming interface (API) requirements from a user;
processing, by the processor, the set of API requirements by extracting a data syntax and a contextual intent of the set of API requirements;
selecting, by the processor, the schema generation strategy by applying the extracted data syntax and the contextual intent to a trained machine inference model; and
generating, by the processor, the graphical schema file based on the selected schema generation strategy.

19. A non-transitory computer readable medium comprising a processor-executable instructions that cause a processor to:
receive an ontology file comprising a domain-specific conceptual model, wherein the domain-specific conceptual model comprises ontological entities and corresponding relationship between ontological entities;
determine a schema generation strategy from at least one of a simple strategy, a nearest neighbor strategy, and a shortest path strategy for the received ontology file based on a user requirement and the received ontology file;
generate an ontological data structure for the received ontology file based on the selected schema generation strategy, wherein the ontological data structure comprises the ontological entities mapped to a plurality of ontological classes in a predefined manner based on the relationship between the ontological entities and based on properties associated with the ontological entities;
transform the generated ontological data structure into a graphical schema structure by mapping each of the ontological entities to corresponding graphical entities based on the selected schema generation strategy and the generated ontological data structure;
generate a graphical schema file for the transformed graphical schema structure by serializing the transformed graphical schema structure; and
output the generated graphical schema file as an Application Programming Interface (API).

20. The non-transitory computer readable medium of claim 19, wherein the processor-executable instructions cause the processor to:
perform one of a one-to-one mapping between a property of an ontological entity with a graphical data property, and a one-to-plurality mapping between the property of the ontological entity with a plurality of graphical data properties.
